(19) United States
(12) Patent Application Publication
(10) Pub. No.: US 2010/0170940 A1
(43) Pub. Date: Jul. 8, 2010

(54) Device for Soldering in the Vapor Phase

(76) Inventor: Helmut W. Leicht, Ebermannstadt (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/227,553

(22) PCT Filed: May 29, 2007
(86) PCT No.: PCT/EP2007/004744

§ 371 Date: Nov. 20, 2008

(30) Foreign Application Priority Data
May 30, 2006 (DE) 10 2006 025 184.9

(51) Int. Cl. B23K 31/02; B23K 3/06; B23K 3/08

(52) U.S. Cl. 228/256; 228/33; 228/43

(57) ABSTRACT

The application describes a soldering device comprising a soldering chamber for receiving a liquid and having a soldering chamber opening, an intermediate chamber arranged at the soldering chamber opening and having a substrate changing opening for supplying and removing items to be soldered, and a closure device for opening and closing the soldering chamber opening and the substrate changing opening. The closure device is designed as a unit such that, when the substrate changing opening is being closed, the soldering chamber opening is opened at the same time and vice versa. This soldering device is cost-effective in both production and operation.

The invention relates to a device and a method for soldering items to be soldered such as, e.g., electronic components on circuit boards. In particular, the device and the method of the invention relate to vapor phase soldering.

During soldering, for example electronic components are connected with a circuit board in an electrically conducting manner. A known possibility of soldering is reflow soldering in which a solder, e.g. in the form of a paste, is applied to corresponding contact points of the circuit board by means of known methods. The components to be soldered are accordingly placed thereon. By supplying heat, e.g. by infrared radiation or vapor, the solder is then brought to a liquid state, and during subsequent cooling the electronic components are connected with the circuit board. The components can be additionally attached to the circuit board, e.g. by means of an adhesive or a fixation means, in order to prevent them from shifting during the soldering process.

Vapor phase soldering, also referred to as VP soldering or vapor phase reflow, is a universal, simple and reliable soldering method, and it is suitable for any kind of surface mounted device (SMD) and support material. For transmitting heat from the environment of the circuit board to the circuit board, this method preferably uses a chemically inert liquid. The boiling point of the liquid is typically at 200° C. or 215° C. In unleaded solders the boiling temperature is higher, at about 230° C. When the liquid boils, an area or a cover of saturated vapor is formed thereon, which, in case an inert liquid is concerned, does not contain oxygen or other gases. Hence, a pure protective gas atmosphere can be formed without the use of additional gases such as nitrogen.

When the item to be soldered immerses into the vapor zone, the vapor condenses on the item to be soldered and transfers its heat to the item to be soldered, wherein the temperature of the item to be soldered can maximally take the temperature of the vapor. Because of this characteristic, the vapor phase soldering process can be reliably reproduced and proceeds in an ideally controllable manner. Hence, different component assemblies, from flexprint to multilayer, can be soldered reliably without being overheated.

However, vapor phase soldering is flawed with the problem that the vapor can escape when the item to be soldered is removed from or supplied to the vapor chamber.

In prior art soldering apparatuses mostly a very complicated and expensive lock structure is used. Thus, it is very difficult to construct cost-effective small machines. In small and cost-effective machines a good sealing-off is not provided, and it is deliberately accepted that a relatively large amount of vapor escapes when supplying and removing the items to be soldered. However, the escaping vapor is very expensive and increases the operating costs of such an apparatus enormously, so that an improvement is desirable also for eco-political reasons. In view of the vapor consumption and the related operating costs, the effort is much higher than the costs for an expensive apparatus using few vapor. Such cost-effective apparatuses can also allow small companies, which only rarely solder assemblies, to produce competitively by using unleaded soldering material, provided the running costs are also low.

Therefore, it is an object of the invention to provide an improved soldering device and an improved method in which the above-mentioned disadvantages are overcome and which allow a cost-effective and efficient vapor phase soldering. This object is achieved by a device and a method comprising the features of the claims.

The invention is based on the idea to open and close a substrate changing opening of the soldering apparatus, which is opened for supplying and removing items to be soldered to/from the soldering device, and a soldering chamber opening through which the items to be soldered are transported into the soldering chamber for being soldered, by means of a closure device which is realized as a unit. The closure device is configured such that by one movement it closes the substrate changing opening and at the same time opens the soldering chamber opening and vice versa, thereby providing a cost-effective and efficient way for limiting the escaping vapor to a sufficiently low level.

In the following, the invention is described in more detail with reference to the drawings in which

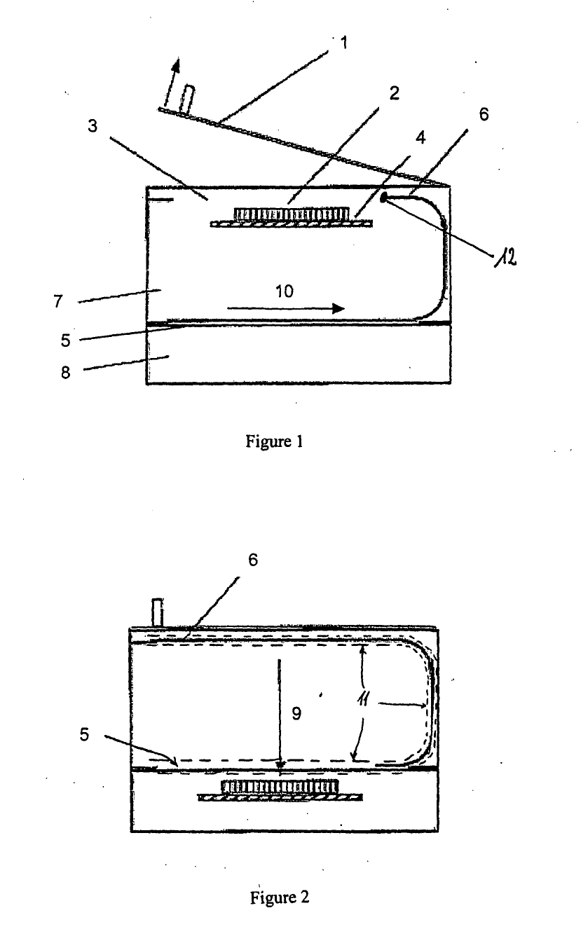

FIG. 1 is a schematic, sectional side view of a device of the invention with open substrate changing opening and closed soldering chamber opening; and

FIG. 2 is a side view similar to that of FIG. 1 but with closed substrate changing opening and open soldering chamber opening.

FIG. 1 shows a soldering device comprising a soldering chamber 8 for receiving a liquid as well as an intermediate chamber 7 arranged thereto, wherein the chambers are connected by a soldering chamber opening 5. The intermediate chamber 7 comprises, in addition to the soldering chamber opening 5, a substrate changing opening 3 on which a movable cover 1 is optionally arranged. The soldering chamber opening 5 and the substrate changing opening 3 are opened and closed by a closure device 6 which closes the soldering chamber opening 5 simultaneously with the opening of the substrate changing opening 3 and vice versa. Between the intermediate chamber 7 and the soldering chamber 8, a substrate holder 4 is arranged so as to be movable through the soldering chamber opening 5. Two essential positions of the substrate holder 4 are the substrate changing position in the intermediate chamber 7, in which item 2 to be soldered can be supplied to and removed from the substrate holder 4, and the soldering position in the soldering chamber 8, in which the item 2 to be soldered is in the vapor zone for being vapor phase soldered.

The soldering chamber 8 preferably comprises a chemically inert liquid, the boiling point of said chemically inert liquid ranging between 150° C. and 250° C., preferably between 175° C. and 225° C., and particularly preferably between 200° C. and 230° C. The liquid, which is liquid at room temperature, is heated to the desired temperature by means of known methods. Immediately after switching on the soldering device, but preferably optionally also only at a specific, manually or electronically controlled time point, the liquid can be heated for generating a vapor zone.

The closure device 6, which consists of a unit, basically comprises at least one flexible material. At least the parts of the closure device 6 which are in contact with the vapor of the liquid represent a barrier that is essentially non-permeable to liquid, and they at least withstand the boiling temperature of the liquid used. The closure device 6 can also be made of a plurality of layers, e.g. of a flexible support material such as a metal sheet which, if necessary, is accordingly coated. The support material can be coated, e.g. with a foil or film or by chemical treatment. The closure device 6 can have the structure of a roller shutter, i.e. consist of a plurality of elements which form a unit and represent a barrier that is non-permeable to the liquid at least in the respective end positions of the closure device 6. When the closure device 6 is changing its position, e.g. during opening and closing the openings, such a roller-shutter structure can temporarily be liquid-permeable for improving the flexibility or bending radius of the closure device 6. For guiding the closure device 6, for example rails or grooves 11 are provided in the area of the two chamber walls that are parallel with respect to the drawing plane, said rails or grooves 11 being shown in dashed manner in FIG. 2 only.

The closure device 6 is preferably operated manually and/or electrically in such a manner that as little vaporous liquid as possible escapes from the soldering device, i.e. the closure device is moved as quickly as possible between the end positions. Preferably, the closure device 6 is operated such that essentially at most the vapor volume filling the intermediate chamber 7 escapes from the soldering device.

In the following, the use of the soldering device is explained in more detail with reference to FIGS. 1 and 2.

An item 2 to be soldered is arranged on the substrate support 4 in the substrate changing position in the intermediate chamber 7. Preferably, the items 2 to be soldered or the parts arranged thereon are fixed on the substrate support 4. Then, the closure device 6 is moved in the direction of arrow 10, i.e. the upper end of the closure device 6 of FIG. 1 is drawn from the right to the left side, e.g. by means of a handle 12 shown in FIG. 1 only, so that the substrate changing opening 3 is closed and at the same time the soldering chamber opening 5 is opened. Thus, a common inner space is formed by the intermediate chamber 7 and the soldering chamber 8. In the intermediate chamber 7, the item to be soldered can optionally also be preheated by the vapor or residual vapor and/or additional means such as an infrared preheater. The item to be soldered can also be preheated by the vapor of the soldering chamber 8, or it can be transported directly by the substrate support 4 in the direction of arrow 9 into the soldering chamber 8 without being preheated. The substrate support 4 is operated and moved in a manually and/or electronically controlled manner by known means.

The item 2 to be soldered is thus transported into the vapor zone in the soldering chamber 8. For specific applications, this supply can be controlled such that a very smooth temperature increase is realized. The vapor condenses on the item 2 to be soldered and transfers its heat. Since the vapor is preferably chemically inert and thus no oxygen is contained in this zone, oxidation of the item to be soldered is excluded. The item to be soldered heats to maximally the temperature of the vapor zone, wherein this temperature is not exceeded even in case of relatively long dwell times.

When the soldering phase is finished, the item 2 to be soldered is transported by the substrate support 4 back into the intermediate chamber 7. After the item 2 to be soldered has been removed from the vapor, the condensate still present on the item to be soldered evaporates preferably without leaving any residues due to the specific heat of the item 2 to be soldered. Optionally, the item 2 to be soldered can be cooled in a controlled manner by removing it in a controlled manner from the vapor phase and/or by additional measures in the intermediate chamber 7, e.g. by blowers.

The closure device 6 is then operated such that the substrate changing opening 3 is opened and at the same time the soldering chamber opening 5 is closed, and then the item 2 to be soldered can be removed.

1. A soldering device comprising a soldering chamber (8) for receiving a liquid and comprising a soldering chamber opening (5), an intermediate chamber (7) arranged at the soldering chamber opening (5) and having a substrate changing opening (3) for supplying and removing items (2) to be soldered, and a closure device (6) for opening and closing the soldering chamber opening (5) and the substrate changing opening (3), characterized in that the closure device (6) is designed as a unit such that, when the substrate changing opening (3) is being closed, the soldering chamber opening (5) is opened at the same time and vice versa.

2. The device according to claim 1, wherein the liquid in the soldering chamber (8) is chemically inert.

3. The device according to claim 1, wherein the boiling point of the liquid is between 150° C. and 250° C.

4. The device according to claim 1, wherein the closure device (6) is made of a material which is essentially non-permeable to the liquid.

5. The device according to claim 1, wherein the material of the closure device (6) withstands at least a temperature corresponding to a boiling temperature of the liquid.

6. The device according to claim 1, wherein the closure means (6) is made of a foil film or a metal sheet.

7. The device according to claim 1, wherein the structure of the closure device (6) is like that of a roller shutter.

8. The device according to claim 1, wherein a substrate support (4) is arranged between a substrate changing position in the intermediate chamber (7) and a soldering position in the soldering chamber (8) in a manner so as to be mechanically or electrically movable.

9. The device according to claim 8, wherein the substrate support (4) is movable from the substrate changing position into the soldering position when the substrate changing opening (3) is closed.

10. A method for vapor phase soldering an item to be soldered, the method comprising the steps of:
opening a substrate changing opening (3) and at the same time closing a soldering chamber opening (5) by a closure device (6);
arranging the item (2) to be soldered on a substrate support (4) in a substrate changing position in an intermediate chamber (7);
closing the substrate changing opening (3) and at the same time opening the soldering chamber opening (5) by the closure device (6);
moving the substrate support (4) with the item (2) to be soldered arranged thereon from the substrate changing position to a soldering position in the soldering chamber (8);
vapor phase soldering the item (2) to be soldered in the soldering chamber (8);
moving the substrate support (4) with the item (2) to be soldered arranged thereon from the soldering position to the substrate changing position;
opening the substrate changing opening (3) and at the same time closing the soldering chamber opening (5);
removing the item (2) to be soldered.
